(19) United States
(12) Patent Application Publication
(10) Pub. No.: US 2011/0227344 A1
(43) Pub. Date: Sep. 22, 2011

(54) METHOD AND APPARATUS FOR USING DE-COMPRESSED FLUID (AIR) AS A COOLANT

(76) Inventors: Ian Raymond Hatton, Grantham (GB); Wilfrid John Hanson, Edmunds (GB)

(21) Appl. No.: 12/887,822

(22) Filed: Sep. 22, 2010

Related U.S. Application Data
(60) Provisional application No. 61/244,856, filed on Sep. 22, 2009.

(51) Int. Cl. H02K 7/18

(52) U.S. Cl. 290/52

(57) ABSTRACT

The present invention includes a system for generating electrical power which may include a data center including at least one equipment which requires electrical power, a renewable power source to generate renewable electric power, a motor to receive the electrical power and to operate a compressor to compress a fluid, a storage device to store the compressed fluid, and a turbine to convert the compressed fluid to operate an electrical generator. The electrical generator may generate electricity to be used by the data center and the storage device may be an underground cavern. The renewable power source may supply electricity directly to the data center, and the turbine may be a high-pressure turbine. The turbine may receive natural gas, and the turbine may be a low-pressure turbine. The system may include a recuperator to receive waste heat from the data center, and the system may include a recuperator to receive waste heat from the turbine.

### PRIORITY

The present invention claims priority under 35 USC section 119 and based upon a provisional application with a Ser. No. 61/244,856 which was filed on Sep. 22, 2009.

### FIELD OF THE INVENTION

The present invention relates to energy savings and more particularly to energy savings associated with a data center.

### BACKGROUND

A data center is a room wherein rows of equipment racks and enclosures situated side by side in very large numbers are located. The equipment racks and enclosures contain and organize communications and information technology equipment, such as servers, internet working equipment and storage devices. Each piece of the rack-mounted equipment consumes electrical power and generates heat. The amount of heat generated corresponds to the amount of power consumed by each piece of equipment.

Naturally, the total heat output of a single rack is the result of a cumulative affect of the heat generated by each piece of rack-mounted equipment. As a result, the heat output of each rack may vary greatly, depending upon the type of equipment, the duty cycle of use of each piece, the ambient temperature, and especially the cooling system being used.

Heat produced by rack-mounted equipment can have adverse effects on the performance, reliability and useful life of the equipment components. In particular, rack-mounted equipment housed within an enclosure is particularly vulnerable to heat build-up and hot spots produced within the confines of the enclosure during operation.

The problem is compounded by a dramatic surge of power consumption in computing systems that has significantly increased the costs of cooling, infrastructure, and energy of data centers and supercomputers. For example, just 25 years ago the typical dissipated power in a computer rack was only about 1 kW while today we are reaching power levels of almost 40 kW in a similar size rack. It is inevitable that future rack power levels will increase even further.

It has been estimated that as much as 50% of the energy used by the data center is converted to heat which typically is removed by chilled water and/or a refrigerant.

Therefore, the cost of removing the heat by air conditioning or cooling by other means of these large scale computing systems has emerged as one of the key challenges for any data center.

The problems with data centers affect many large-scale facilities that generate heat as a byproduct of the operation of these facilities. Traditionally, chilled water and/or refrigerant was used to remove the excess heat by specialized equipment including chillers, direct expansion refrigerant-based condensers, condensing units, compressors, heat exchangers and cooling towers. Water and/or refrigerant may be an efficient media for the transfer of heat but is not the only media that may be used. Other fluids such as air may provide an acceptable media for the transfer of heat from the facilities.

FIG. 3 illustrates an energy storing plant which stores energy in the form of pressurized air which is subsequently used to generate electrical power or other uses. Off peak electricity or excess electricity may be used to pre-compress the air which may be stored in a storage facility such as a underground cavern which could be a salt cavern. When it is desired to regenerate the electricity from the compressed air, the compressed air is released from the cavern and heated by a recuperator before being mixed with the fuels such as natural gas and expanded through a turbine to generate electricity.

### SUMMARY

The present invention includes a system for generating electrical power which may include a data center including at least one equipment which requires electrical power, a renewable power source to generate renewable electric power, a motor to receive the electrical power and to operate a compressor to compress a fluid, a storage device to store the compressed fluid, and a turbine to convert the compressed fluid to operate an electrical generator.

The is electrical generator may generate electricity to be used by the data center and the storage device may be an underground cavern.

The renewable power source may supply electricity directly to the data center, and the turbine may be a high-pressure turbine.

The turbine may receive natural gas, and the turbine may be a low-pressure turbine.

The system may include a recuperator to receive waste heat from the data center, and the system may include a recuperator to receive waste heat from the turbine.

The fluid may be air.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a data center in accordance with the present invention;

FIG. 2 illustrates the data center and energy source associated with the data center; and

FIG. 3 illustrates an alternative power source;

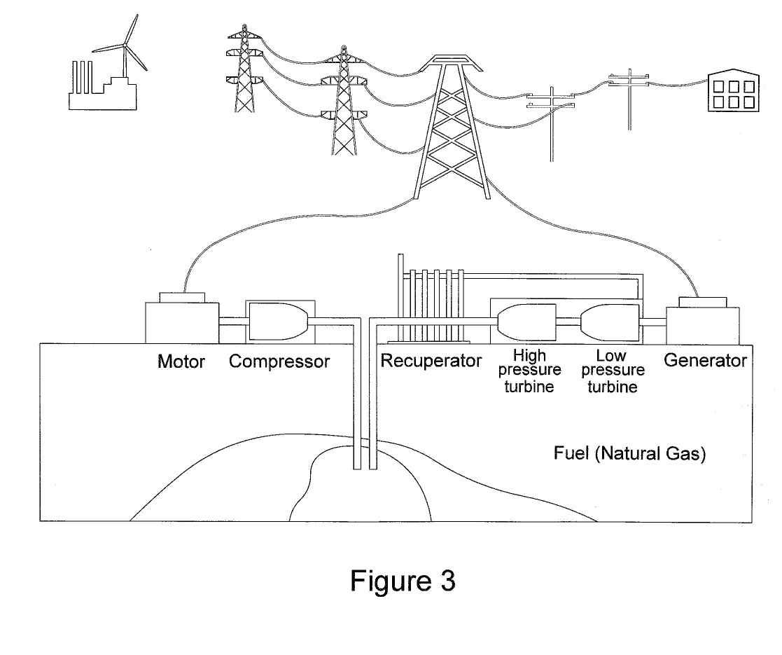

FIG. 4 illustrates a controller scheme of the present invention.

### DETAILED DESCRIPTION

The present invention includes a method and apparatus for providing chilled fluid such as air to a data center 117 in order to dissipate waste heat from the data center 117. When the compressed fluid such as air is returned to substantially atmospheric pressure in a controlled environment, cooling is a result of an adiabatic expansion of the compressed air. The air, as it is released from a constrained environment, performs work on the atmosphere by pushing the atmosphere away and against atmospheric pressure to accommodate the expanded air. The amount work, delta W equals P (atmosphere)*Delta V (the additional volume that the expanded air occupies). This assumes that delta Q=0 (adiabatic process) and the work is performed at the expense of internal energy of the expanding air which is why the air cools down.

In one preferred embodiment, the invention utilizes off-shore structures (or alternatively on shore structures) to build wind farms in areas that generally have naturally occurring wind conditions and that are generally remote from highly occupied territory, including abandoned or de-commissioned oil and gas platforms. The present invention may employ other sources of electrical power including nuclear, solar, water power or the like.

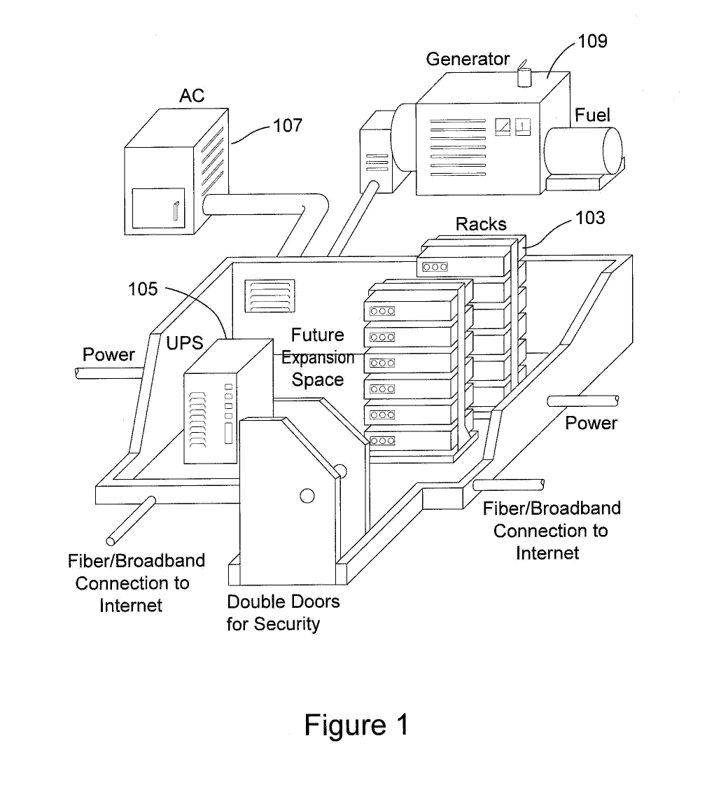

FIG. 1 illustrates a data center layout with a number of high voltage alternating current HVAC and backup power supplies. Data centers 101 (also known as server farms) are large consumers of electricity. Current usage indicates that these centers are responsible for approximately 1% to 1.5% of total world electricity consumption. This is expected to increase to between 2% and 3% of total world electricity consumption in the next 10 years at the current growth rate of approximately 16% per annum. Data centers alone consume >3% of electricity used in the US.

FIG. 1 illustrates a rack mounted equipment 103 which may include heat generating equipment, a UPS 105 to provide an uninterruptible power supply for the data center 101, an air conditioning unit 107 to supply air conditioning to the data center 101, a power generator 109 to supply AC power to the data center 101.

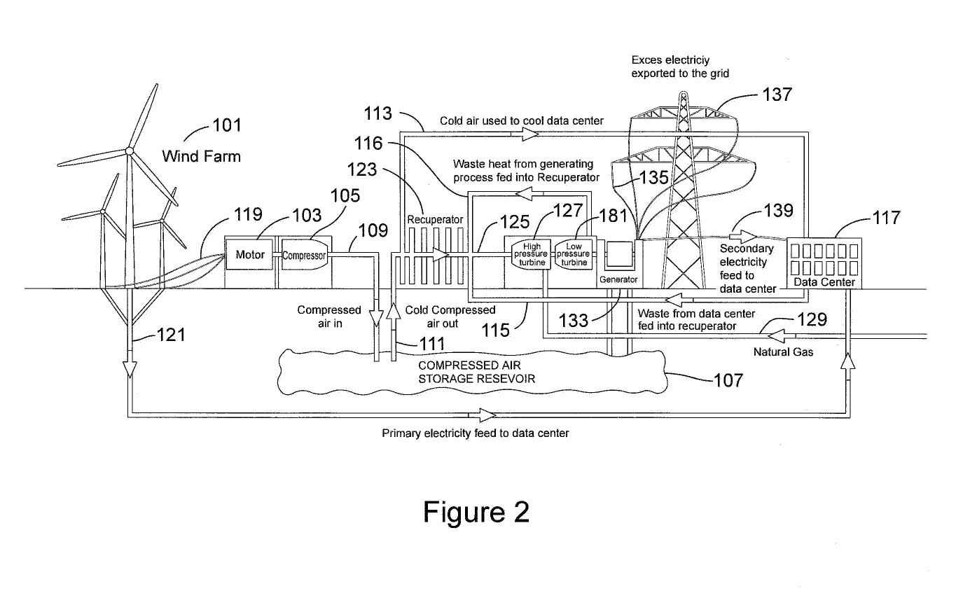

FIG. 2 is a schematic of a method and apparatus which may be dedicated to implementing the cooling of the data center 117. The energy sources may be dedicated to the data center 101. FIG. 2 illustrates a renewable energy source 101 which may be a windfarm, nuclear power plant, solar or other type of energy source. Wind energy may be converted to electrical energy which is just one form of renewable energy and which may be generated from the windfarm 101. The electrical energy from the renewable energy source 101 may be transmitted over a first transmission line 119 through the motor 103, or alternatively the electrical energy from the renewable energy source 101 may be transmitted over a second transmission line 121 directly to the data center 117.

The electrical energy transmitted over the first transmission line 119 may energize the motor device 103 which may drive a shaft which may be connected to the compressor 105 which may compress a fluid such as air. The compressed air from the compressor 105 may be transmitted over a first passageway 109 to a storage device 107 which may be an underground storage device such as a tank or underground reservoir. Alternatively, the storage device 107 may be above ground. The compressed air may remain in the storage device 107 until cooling is required by the data center 117. The compressed air may flow through the passageway 111 and then through the third passageway 113 to connect to the data center 117 where the compressed air may be used to cool the data center 117. When the compressed air alternatively is required, the compressed air flows through the second passageway 111 to the recuperator 123 which may be a special purpose counter-flow energy recovery heat exchanger used to recover waste heat from exhaust gases and where the waste from the data center 117 along the fourth passageway 115 or alternatively from the second turbine 131 which may be a low-pressure turbine. The compressed air may be output from the recuperator 123 along the fifth passageway 125 to the high pressure turbine 127 where the compressed air may be mixed with natural gas. The natural gas may be transmitted along the sixth passageway 129 from a source of natural gas (not shown) to the high-pressure turbine 127. The compressed air from the recuperator 123 may be transmitted along the second passageway 125 to the first turbine 127 which may be a high-pressure turbine. The exhaust from the first turbine 127 may be connected to the second turbine 131 which may be a low-pressure turbine. The first turbine 127 and the second turbine 131 may be connected to a generator 133 which may generate electricity which may be connected to a third transmission line 135 to connect to the power grid 137 or may be connected to a fourth transmission line 139 to provide electricity for the data center 117.

The wind turns the turbine of the windfarm 101 to generate electricity which may be transmitted to the data center 117 over the second transmission line 121 or may be transmitted to the motor 103 over the first transmission line 119. The motor 103 may be connected to a compressor 105 and may operate the compressor so that the compressor 105 compresses air which may be transmitted to a storage device 107 over a first passageway 109. The compressed air may be stored in the storage device 107 until required and may be transmitted from the storage device 107 through the second passageway 111. The compressed air may be transmitted directly to the data center 117 by the third passageway 113 or may be transmitted to the recuperator 123 which may receive waste heat from the data center 117 over the fourth passageway 115 or may receive waste heat from the low-pressure turbine 131 over the seventh passageway 116. The exhaust gas from the recuperator 123 is transmitted to the high-pressure turbine 127 over the fifth passageway 125. The high-pressure turbine 127 may receive natural gas from the sixth passageway 129. The low-pressure turbine 181 may be connected to the generator 133 which may generate electrical power which may be transmitted over the third transmission line 135 to the power grid 137. Alternatively, the generator 133 may generate electrical power which may be transmitted over the fourth transmission line 139 to the data center 117.

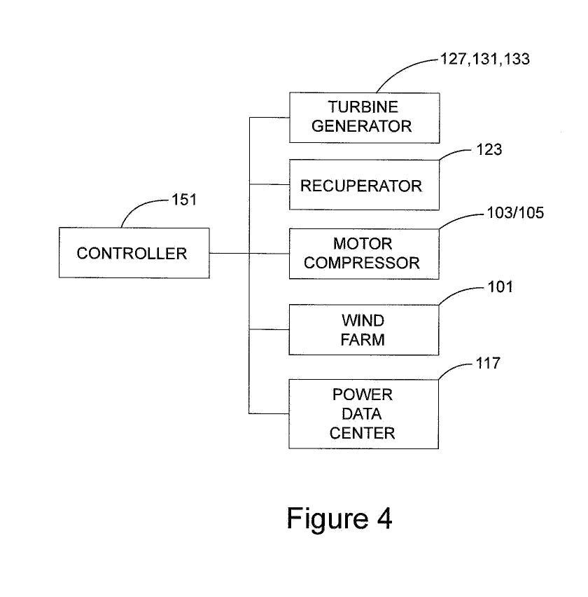

FIG. 4 illustrates a controller 151 which may control the turbine and generator 127, 131, 133, the recuperator 123, the motor and compressor 103, 105, the windfarm 101 and the power to the data center 117.

The foregoing disclosure and description of the invention are illustrative and exemplary thereof, and various changes in the size, shape and materials, as well as in the details of the illustrated construction, may be made without departing from the spirit of the invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A system for generating electrical power, comprising:
a data center including at least one equipment which requires electrical power;
a renewable power source to generate renewable electric power;
a motor to receive the electrical power and to operate a compressor to compress a fluid;
a storage device to store the compressed fluid;
a turbine to convert the compressed fluid to operate an electrical generator;
the electrical generator generating electricity to be used by the data center.

2) as in claim 1, wherein the storage device is an underground cavern.

3) as in claim 1, wherein the renewable power source supply electricity directly to the data center.

4) as in claim 1, wherein the turbine is a high-pressure turbine.

5) as in claim 4, wherein the high pressure turbine receives natural gas.

6) as in claim 1, wherein the turbine is a low-pressure turbine.

7) as in claim 1, wherein the system includes a recuperator to receive waste heat from the data center.

8) as in claim 1, wherein the system includes a recuperator to receive waste heat from the turbine.

9) as in claim 1, wherein the fluid is air.
